(19) United States
(12) Patent Application Publication
(10) Pub. No.: US 2008/0002710 A1
(43) Pub. Date: Jan. 3, 2008

(54) SYSTEM AND METHOD FOR ROUTING COMMUNICATIONS TO MOBILE STATIONS

(75) Inventors: Ajaykumar R. Idnani, Hoffman Estates, IL (US); Jason W. Lau, Singapore (SG); Steven D. Upp, Bartlett, IL (US); Timothy J. Wilson, Rolling Meadows, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/427,550

(22) Filed: Jun. 29, 2006

(51) Int. Cl. H04L 12/56

(52) U.S. Cl. 370/395.2

(57) ABSTRACT

A Session Initiation Protocol (SIP)-compliant proxy (106) receives a first INVITE message destined for a mobile station (102). The first INVITE message is associated with an initial Internet Protocol (IP) contact address for the mobile station (102). Subsequently, it is determined whether an IP address update for the mobile station (102) may have occurred and a new IP contact address is obtained for the mobile station (102). A second INVITE message is sent to the mobile station (102) at the new contact address so as to continue a session initiation.

### FIELD OF THE INVENTION

The field of the invention relates to routing communications through networks and, more specifically, to routing communications to mobile stations as these mobile stations move through networks.

### BACKGROUND OF THE INVENTION

Mobile stations frequently move between different areas of networks and/or between different types of networks. For example, mobile stations often move between different sub-networks within Wireless Local Area Networks (WLANs). When a mobile station moves from one sub-network to another within the WLAN, the mobile station typically changes its Internet Protocol (IP) address.

In WLAN systems, a Radio Access Network (RAN) typically tunnels data from an old sub-network to a new sub-network until the RAN receives a Dynamic Host Configuration Protocol (DHCP) request that originates at the mobile station. The DHCP request indicates that the mobile station is changing sub-networks and IP addresses. Unfortunately, during the time the IP address of the mobile station is changing, any call destined for the mobile station will not reach the mobile station. Consequently, a time period of, for example, a few seconds exists during which the mobile station will not be reachable by other users.

Previous approaches have not adequately addressed the above-mentioned coverage problem. For example, in some previous systems, a home agent was used to tunnel all IP packets to a foreign address associated with the mobile station in order to reach the mobile station. However, when a large number of users existed in the network, scalability became a concern. In addition, since an extra hop to the foreign address was required to be made, performance of these systems often became degraded and non-optimal.

In other previous approaches, a denied request to contact the mobile station was retransmitted. Unfortunately, this approach consumed too much system bandwidth since the number of retries was often substantial. Moreover, since the request still included the old address of the mobile station, the request never reached the new IP address where the mobile station was operating. Because of the numerous shortcomings of these previous approaches, system performance became downgraded, calls were lost, and user frustration with the system increased whenever mobile stations moved and changed IP addresses.

### BRIEF DESCRIPTION OF THE DRAWINGS

FIG. 1 is a block diagram of a system for routing information to a mobile station according to various embodiments of the present invention;

FIG. 2 is a flowchart of an approach for routing information to the correct contact address of a mobile station according to an embodiment of the present invention;

FIG. 3 is a flowchart of an approach for routing information to the correct contact address of a mobile station according to another embodiment of the present invention;

FIG. 4 is a flowchart of an approach for routing information to the correct contact address of a mobile station according to another embodiment of the present invention;

FIG. 5 is a flowchart of an approach for routing information to the correct contact address of a mobile station according to another embodiment of the present invention;

FIG. 6 is a flowchart of an approach for routing information to the correct contact address of a mobile station according to another embodiment of the present invention;

FIG. 7 is a block diagram of a SIP-compliant proxy according to an embodiment of the present invention;

FIG. 8 is a block diagram of a mobile station according to an embodiment of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method are provided that route messages to the correct address of the mobile station even as the mobile station moves across a network and changes addresses. The approaches described herein are efficient to perform and do not require the performance of extra messaging sequences. Moreover the performance of the system is enhanced, and calls are not dropped when users move between different areas of the network.

In many of these embodiments, a Session Initiation Protocol (SIP)-compliant proxy receives a first INVITE message destined for a mobile station. The first INVITE message is associated with an initial Internet Protocol (IP) contact address for the mobile station. Subsequently, it is determined whether an IP address update for the mobile station may have occurred and a new IP contact address is obtained for the mobile station. A second INVITE message is then sent to the mobile station at the new contact address in order to continue a session initiation.

Whether an address update occurred may be determined based upon several conditions. For instance, a retry attempt of the first INVITE message may be received. In another example, an update message may be received from a SIP-compliant registrar indicating that the address update has occurred. In yet another example, it may be determined that a predetermined period of time has expired. In this case, a second INVITE message may be sent from the SIP-compliant proxy to the mobile station (at the new contact address) upon expiration of the predetermined period of time.

In others of these embodiments, a mobile station operates and receives communications at a first Internet Protocol (IP) address. A second IP address is acquired and this second IP address is the new operating address for the mobile station. The IP stack at the mobile station is not initialized with this second IP address at this time. It is delayed until a later point as in time. The second IP address is registered at a Session Initiation Protocol (SIP)-compliant register and a first INVITE message is subsequently sent to and received at the mobile station. Subsequent to registering the second IP address, the IP stack at the mobile station is initialized to be able to use the second IP address.

A race condition is prevented from occurring at the mobile station based upon the particular messaging sequence that occurs. For example, when the first INVITE message (associated with the first IP address) is received by the mobile station before stack initialization occurs, a redirect message may be sent by mobile station to a SIP-compliant proxy. The message indicates that the mobile station has moved to the second IP address. Since the redirect message informs the SIP-compliant proxy of the new address, subsequent INVITE messages will include the second IP address and, consequently, will be received at the mobile station.

In another example, when the mobile station moves to the new address but has not initialized its stack with the new address, INVITE messages (with the new address) are not received. In this situation, after initialization is performed, retry attempts of the INVITE message (with the new address) may be made and will be successfully received by the mobile station.

Thus, approaches are provided that allow messages and communications to be routed to mobile stations as these mobile stations move across networks and change addresses. The approaches provided avoid dropped calls, do not negatively impact system performance, do not require extra messaging sequences, and avoid the creation of scalability problems.

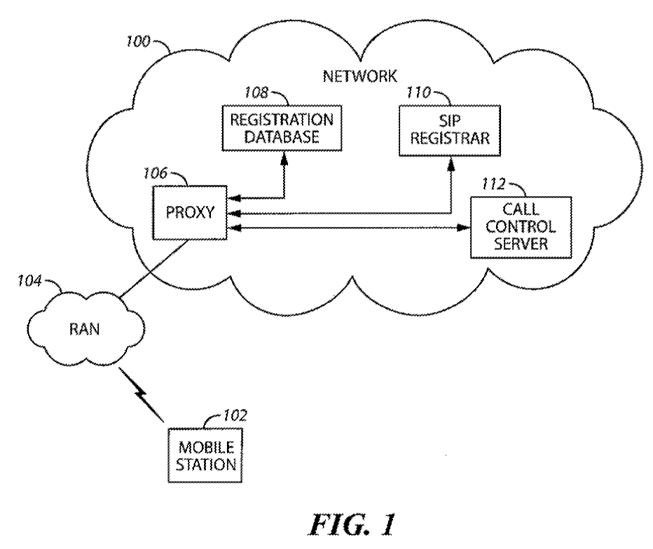

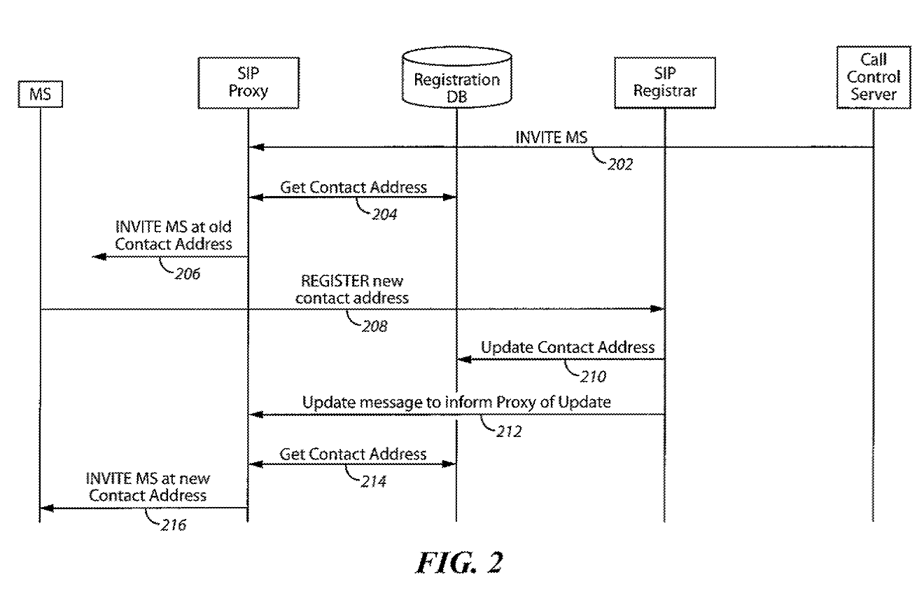

Referring now to FIG. 1, an example of a system for routing information to the correct contact address of a mobile station is described. The system includes a network 100. The network 100 includes a SIP-compliant proxy 106, a registration database 108, a SIP-compliant registrar 110, and a call controller 112. A RAN 104 is coupled to the network 100, for example, to the proxy 106. A mobile station 102 communicates with the RAN 104. The system described in FIG. 1 may be used to implement the approaches for routing information described in FIGS. 2 through 6.

The SIP-compliant proxy 106 is a server that provides for centralized address translation. The SIP-compliant proxy 106 receives INVITE and other messages from the call controller 112 and forwards these to the mobile station 102.

The registration database 108 stores information regarding the status and location of mobile stations operating in the network. For example, the registration database may store the current contact address of mobile stations that are operating in the network.

The SIP-compliant registrar 110 communicates with the registration database 108 to update information in the registration database 108. For example, the SIP-compliant register 110 may change the contact address that is stored in the registration database 108 as the contact address changes. The call controller 112 provides basic control, advanced call services and connectivity to a Public Switched Telephone Network (PSTN).

The RAN 104 includes elements and functionality that allow the mobile station 102 to communicate with the network 100 and the network 100 to communicate with the mobile station 102. In this regard, the RAN 104 may include base stations, base station controllers, servers, gateways, and/or other elements that allow these functions to be performed.

The mobile station 102 may be any type of mobile wireless communication device. For example, the mobile station 102 may be a cellular telephone, pager, personal digital assistant, or personal computer. Other examples of mobile stations are possible.

In one embodiment of the present invention, the system of FIG. 1 may operate as follows. The SIP-compliant proxy 106 receives a first INVITE message destined for the mobile station 102. The first INVITE message is associated with an initial Internet Protocol (IP) contact address for the mobile station 102. Subsequently, the SIP-compliant proxy 106 determines whether an IP address update for the mobile station 102 may have occurred and, if an update has occurred, obtains a new IP contact address for the mobile station 102. The SIP-compliant proxy 106 then sends a second INVITE message to the mobile station 102 at the new contact address so as to continue a session initiation.

Whether an address update occurred may be determined based upon several factors. For instance, a retry attempt of the first INVITE message may be received. In another example, an update message from the SIP-compliant registrar 110 indicating that the address update has occurred may be received. In yet another example, it may be determined that a predetermined period of time has elapsed. In this case, the second INVITE message is sent from the SIP-compliant proxy 106 to the mobile station 102 (via the RAN 104) with the new contact address upon expiration of the predetermined period of time.

In another embodiment of the present invention, the system of FIG. 1 may operate as follows. The mobile station 102 operates at and receives communications at a first IP address. The mobile station acquires a second IP address, the second IP address being a new operating address of the mobile station 102. The IP stack at the mobile station is not initialized with the second IP address at this time. The mobile station 102 registers the second IP address at the SIP-compliant registrar 110 and, subsequent to registering the second IP address, the mobile station initializes its stack to use the second IP address. A conveyance of a first INVITE message to the mobile station 102 is delayed until after the mobile station initializes its stack, and after the stack is initialized the mobile station receives the first INVITE message. An occurrence of a race condition is prevented at the mobile station 102 because of the mobile station operating at the second IP address.

The actions taken to prevent the race condition depend upon the particular messaging sequence that occurs. For example, when the first INVITE message (associated with the first IP address) is received by the mobile station 102 before stack initialization occurs, a redirect message may be sent by mobile station 102 to the SIP-compliant proxy 106. The message indicates that the mobile station 102 has moved to the second IP address. Since the redirect message informs the SIP-compliant proxy 106 of the new address, subsequent INVITE messages will include the second IP address and, consequently, will be received at the mobile station 102 thereby preventing the race condition from occurring.

In yet another embodiment of the present invention, when the mobile station 102 has informed the registrar of the new address, but has not initialized its stack to use the new address, INVITE messages (with the new address) are not received at the mobile station 102. In this situation, after initialization is performed, retry attempts of the INVITE message (with the new address) may be made (e.g., from the proxy 106) and will be successfully received by the mobile station 102.

Referring now to FIG. 2, an approach for routing information to the correct contact address of a mobile station is described in accordance with an embodiment of the present invention. At step 202, a call control server sends an INVITE message to a SIP-compliant proxy. The INVITE message is destined for the mobile station (MS). At step 204, the SIP-compliant proxy obtains a contact address from a Registration Database (DB). Unless otherwise specified, references herein to contact addresses preferably refer to IP addresses. At step 206, an INVITE message is sent to the mobile station (MS) at an initial contact address.

At step 208, the mobile station registers a new contact address at a SIP-compliant registrar. At step 210, the SIP-compliant registrar updates the Registration Database (DB) with a new contact address. At step 212, the SIP-compliant registrar sends an update message to the SIP-compliant proxy informing the SIP proxy that an update has occurred. At step 214, the SIP-compliant proxy gets the new contact address from the Registration Database (DB). At step 216, the SIP-compliant proxy sends a second INVITE message to the mobile station. This INVITE message has the new contact address, so the INVITE message reaches the SIP-compliant proxy.

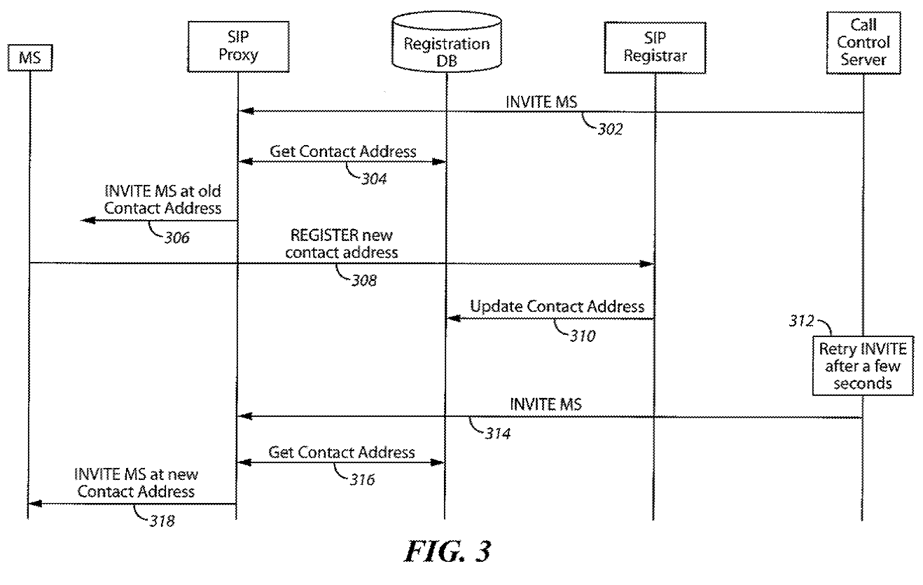

Referring now to FIG. 3, an approach for routing information to the correct contact address of a mobile station is described in accordance with another embodiment of the present invention. At step 302, a call control server sends an INVITE message to a SIP-compliant proxy. The INVITE message is destined for the mobile station (MS). At step 304, the SIP-compliant proxy gets a contact address from a Registration Database (DB). At step 306, an INVITE message is sent to the mobile station (MS) at an initial contact address.

At step 308, the mobile station registers a new contact address at a SIP-compliant registrar. At step 310, the SIP-compliant registrar updates the Registration Database (DB) with a new contact address. At step 312, the call control server retries the INVITE message after a predetermined time period has elapsed. For instance, a timer may be used and the timer may be set to expire after a few seconds. At step 314, an INVITE message is sent from the call control server to the SIP-compliant proxy. At step 316, the SIP-compliant proxy retrieves the new contact address from the Registration Database (DB). At step 318, the SIP-compliant proxy sends a second INVITE message to the mobile station. This INVITE message includes the new contact address, so the INVITE message reaches the mobile station.

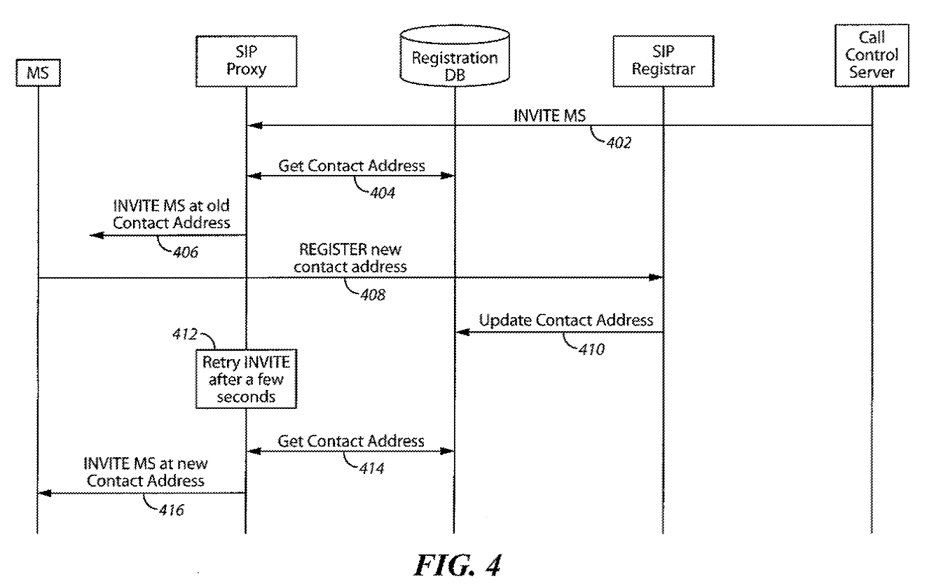

Referring now to FIG. 4, an approach for routing information to the correct contact address of a mobile station is described in accordance with yet another embodiment of the present invention. At step 402, a call control server sends an INVITE message to a SIP-compliant proxy. The INVITE message is destined for the mobile station (MS). At step 404, the SIP-compliant proxy gets a contact address from a Registration Database (DB). At step 406, an INVITE message is sent to the mobile station (MS) at an initial contact address.

At step 408, the mobile station registers a new contact address at a SIP-compliant registrar. At step 410, the SIP-compliant registrar updates the Registration Database (DB) with a new contact address. At step 412, the SIP-compliant proxy retries the INVITE after the expiration of a predetermined time interval. At step 414, the SIP-compliant proxy retrieves the new contact address from the Registration Database (DB). At step 416, the SIP-compliant proxy sends a second INVITE message to the mobile station. This INVITE message has the new contact address, so the INVITE message reaches the mobile station.

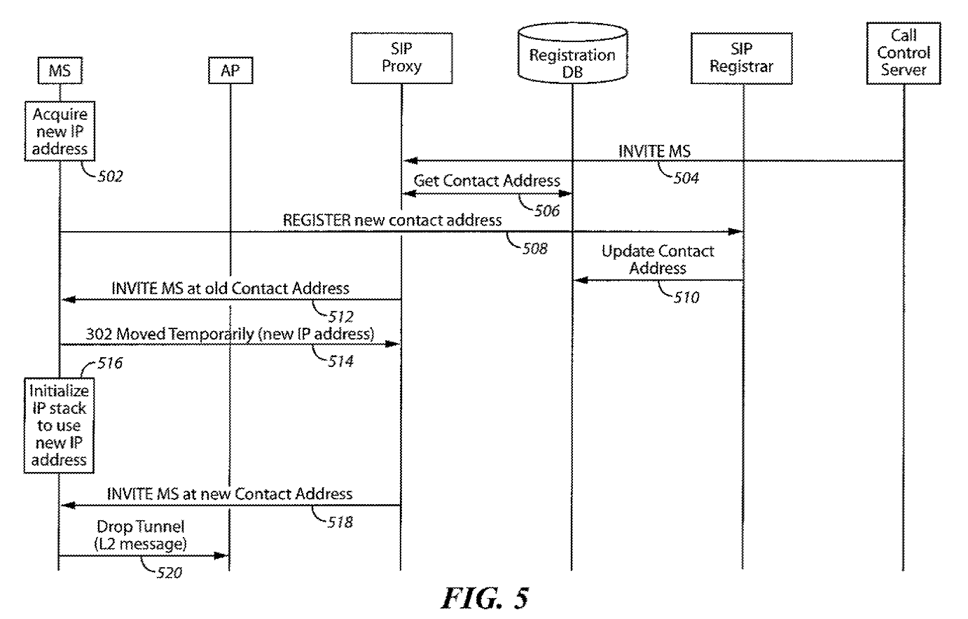

Referring now to FIG. 5, an approach for routing information to the correct contact address of a mobile station is described in accordance with still another embodiment of the present invention. At step 502, the mobile station (MS) acquires a new contact address. At step 504, an INVITE message is sent from a call control server to a SIP-compliant proxy. At step 506, the SIP-compliant proxy obtains an old contact address, that is, an address that preceded the new contact address, of the mobile station (MS) from a Registration Database (DB). At step 508, the mobile station (MS) registers the new contact address with a SIP-compliant registrar. At step 510, the SIP-compliant registrar updates the contact address in the Registration Database (DB).

At step 512, the SIP-compliant proxy sends an INVITE to the mobile station (MS) at the old contact address of the mobile station. At step 514, the mobile station (MS) sends a redirect message (e.g., a 302 moved temporary message) to the SIP-compliant proxy. The message includes the new contact address of the mobile station (MS). At step 516, the mobile station (MS) initializes the IP stack of the mobile station (MS) to use the new contact address. At step 518, the SIP-compliant proxy sends an INVITE message to the mobile station (MS) at the new contact address. At step 520, the mobile station (MS) sends a drop tunnel message (e.g., a Layer 2 (L2) message) to an access point (AP) and a tunnel associated with the mobile station and based on the old contact address is subsequently dropped by the access point.

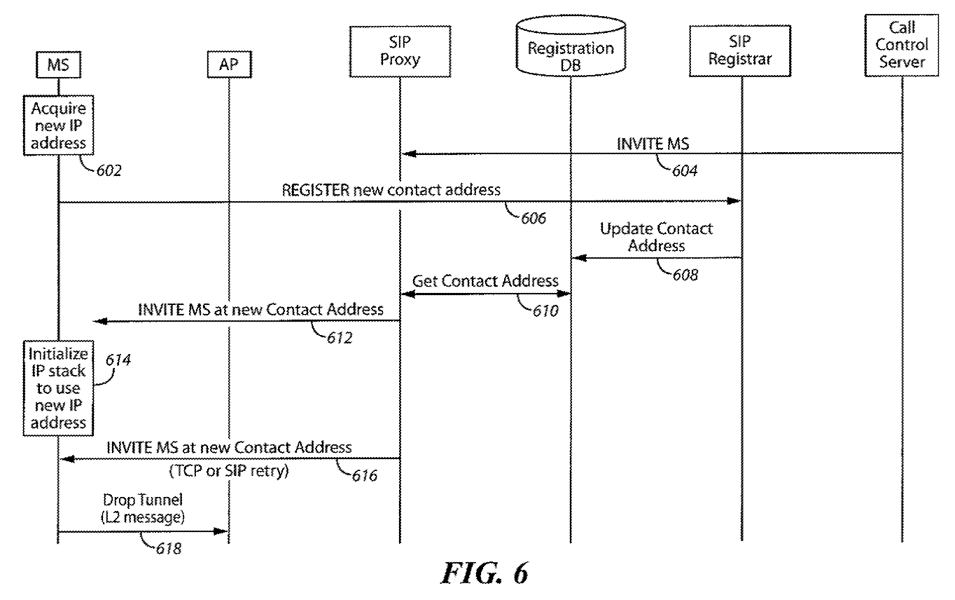

Referring now to FIG. 6, an approach of routing information to the correct contact address of a mobile station is described in accordance with yet another embodiment of the present invention. At step 602, the mobile station (MS) acquires a new contact address. At step 604, an INVITE message is sent from a call control server to a SIP-compliant proxy. At step 606, the SIP-compliant proxy obtains an old contact address, that is, an address that preceded the new contact address, of the mobile station (MS) from a Registration Database (DB). At step 608, the mobile station (MS) registers the new contact address with a SIP-compliant registrar. At step 610, the SIP-compliant registrar updates the contact address in the Registration Database (DB) with the new contact address.

At step 612, the SIP-compliant proxy sends an INVITE to the mobile station (MS) at the new contact address. At step 614, the mobile station (MS) initializes the IP stack of the mobile station (MS) to use the new contact address. At step 616, the SIP-compliant proxy sends an INVITE to the mobile station (MS) at the new contact address. The INVITE may be in the form of a TCP or SIP-compliant retry. At step 618, the mobile station (MS) sends a drop tunnel message (a Layer 2 (L2) message) to an access point and a tunnel associated with the mobile station and based on the old contact address is subsequently dropped by the access point.

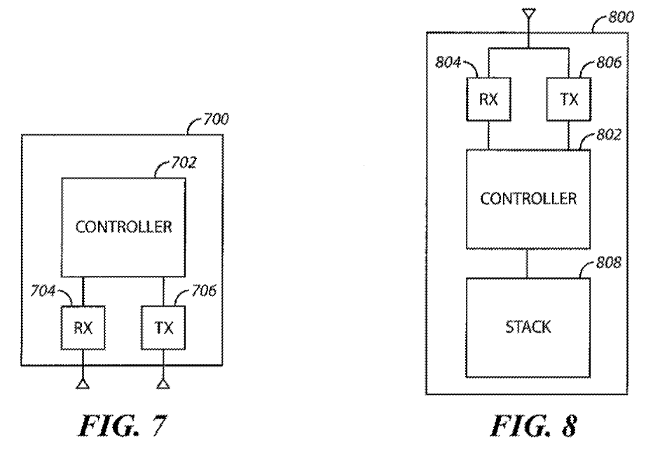

Referring now to FIG. 7, a SIP-compliant proxy 700, such as SIP-compliant proxy 106, is described in accordance with an embodiment of the present invention. The SIP-compliant proxy 700 includes a controller 702, a receiver 704, and a transmitter 706. The receiver 702 receives a first INVITE message destined for a mobile station. The first INVITE message is associated with an initial IP contact address. The controller 706 is programmed to determine whether an address update has occurred and to obtain a new IP contact address for the mobile station. The controller 706 is further programmed to responsively send a second INVITE message to the mobile station at the output of the transmitter 704. The second INVITE message is associated with the new IP contact address so as to continue a session initiation.

Referring now to FIG. 8, a mobile station 800, such as mobile station 102, is described in accordance with an embodiment of the present invention. The mobile station 800 includes a controller 802, a receiver 804, a transmitter 806, and a stack 808. In an example of the operation of the system of FIG. 8, the mobile station 800 operates at and receives communications at a first Internet Protocol (IP) address. The communications are received at the receiver 804. A second IP address is acquired by the mobile station 800. The second IP address is the new operating address of the mobile station 800.

The second IP address is registered at a SIP-compliant registrar and a first INVITE message is subsequently received at the input of the receiver 804. Subsequent to registering the second IP address, the stack 808 at the mobile station 800 is initialized to use the second IP address. An occurrence of a race condition is prevented at the mobile station 800 because of the mobile station 800 moving to the second IP address 102. As has been described elsewhere in this specification, the actions taken to prevent the race condition depend upon the particular messaging sequence that occurs and include initializing the stack 808 and receiving a retry attempt, or sending a redirect message (with the new address) to a SIP-compliant proxy and, consequently, receiving messages that are directed to the second address.

Thus, approaches are provided that allow messages and communications to be routed to mobile stations as these mobile stations move across networks. The approaches avoid dropped calls, do not negatively impact system performance, do not require extra messaging, and do not create appreciable scalability problems.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of transmitting information in a network comprising:
at a Session Initiation Protocol (SIP)-compliant proxy:
receiving a first INVITE message destined for a mobile station, the first INVITE message being associated with an initial Internet Protocol (IP) contact address for the mobile station;
subsequently determining whether an IP address update for the mobile station has occurred and obtaining a new IP contact address for the mobile station; and
sending a second INVITE message to the mobile station at the new contact address so as to continue a session initiation.

2. The method of claim 1 wherein determining whether an IP address update has occurred comprises receiving a retry attempt of the first INVITE message.

3. The method of claim 1 wherein determining whether an IP address update has occurred comprises receiving an update message from a SIP-compliant registrar indicating that the address update has occurred.

4. The method of claim 1 wherein determining whether an IP address update has occurred comprises determining that a predetermined period of time has elapsed.

5. The method of claim 4 wherein sending the second INVITE message comprises sending the second INVITE message from the SIP-compliant proxy to the mobile station with the new contact address upon expiration of the predetermined period of time.

6. A method of transmitting information in a network comprising:
at a mobile station:
operating at and receiving communications at a first Internet Protocol (IP) address;
acquiring a second IP address, the second IP address being a new operating address of the mobile station;
registering the second IP address at a Session Initiation Protocol (SIP)-compliant registrar and subsequently receiving an INVITE message;
subsequent to registering the second IP address, initializing an IP stack at the mobile station to use the second IP address; and
preventing an occurrence of a race condition at the mobile station because of the mobile station operating at the second IP address.

7. The method of claim 6 wherein receiving an INVITE message comprises receiving an INVITE message associated with the first IP address, and wherein preventing an occurrence of a race condition comprises sending a redirect message to a SIP-compliant proxy, the message indicating that the mobile station has moved to the second IP address.

8. The method of claim 7, wherein the INVITE message comprises a first INVITE message and wherein the method further comprises successfully receiving a second INVITE message associated with the second IP address.

9. The method of claim 6 further comprising successfully receiving a retry attempt of the INVITE message, the INVITE message being associated with the second IP address.

10. The method of claim 6, wherein receiving an INVITE message comprises receiving an INVITE message that has been delayed until the IP stack at the mobile station has been initialized to use the second IP address.

11. A Session Initiation Protocol (SIP)-compliant proxy comprising:
a receiver having an input that receives a first INVITE message destined for a mobile station, the first INVITE message having an initial Internet Protocol (IP) contact address;
a transmitter having an output; and
a controller coupled to the receiver and the transmitter, the controller being programmed to determine whether an address update has occurred and to responsively obtain a new IP contact address for the mobile station, the controller being further programmed to responsively send a second INVITE message to the mobile station at the output of the transmitter, the second INVITE message associated with the new IP contact address so as to continue a session initiation.

12. The SIP-compliant proxy of claim 11 wherein the controller determines that an address update has occurred based upon reception of a retry attempt of the first INVITE message at the input of the receiver.

13. The SIP-compliant proxy of claim 11 wherein the controller determines that an address update has occurred based upon the reception of an update message from a SIP-compliant registrar at the input of the receiver.

14. The SIP-compliant proxy of claim 11 further comprising a timer that operably couples to the controller and wherein the controller is further programmed to determine that an address update has occurred based upon expiration of a predetermined time period at the timer.

15. The SIP-compliant proxy of claim 11 wherein the controller obtains the new IP contact address from a registration database.

16. A mobile station that is configured to operate at and receive communications at a first Internet Protocol (IP) address, acquire a second IP address, the second IP address being a new operating address of the mobile station, register the second IP address at a Session Initiation Protocol (SIP)-compliant registrar and subsequently receive an INVITE message, subsequent to registering the second IP address, initialize a stack at the mobile station to use the second IP address, and prevent an occurrence of a race condition at the mobile station because of the mobile station operating at the second IP address.

17. The mobile station of claim 16, wherein the mobile station is configured to receive an INVITE message by receiving an INVITE message associated with the first IP address, and wherein the mobile station prevents an occurrence of a race condition by sending a redirect message to a SIP-compliant proxy, the message indicating that the mobile station has moved to the second IP address.

18. The mobile station of claim 17, wherein the INVITE message comprises a first INVITE message and wherein the mobile station is further configured to successfully receive a second INVITE message associated with the second IP address.

19. The mobile station of claim 16, wherein the mobile station further is configured to successfully receive a retry attempt of the INVITE message, the INVITE message being associated with the second IP address.

20. The mobile station of claim 16, wherein the mobile station is configured to receive an INVITE message by receiving an INVITE message that has been delayed until the IP stack at the mobile station has been initialized to use the second IP address.
